(19) United States
(12) Patent Application Publication
(10) Pub. No.: US 2019/0296273 A1
(43) Pub. Date: Sep. 26, 2019

(54) BATTERY CELL FOR ELECTRIC VEHICLE BATTERY PACK

(71) Applicant: SF Motors, Inc., Santa Clara, CA (US)

(72) Inventors: Yifan Tang, Santa Clara, CA (US); Chien-Fan Chen, Santa Clara, CA (US); Ying Liu, Santa Clara, CA (US)

(21) Appl. No.: 16/153,161

(22) Filed: Oct. 5, 2018

Related U.S. Application Data
(60) Provisional application No. 62/646,981, filed on Mar. 23, 2018.

(51) Int. Cl. H01M 2/04; H01M 2/26; B60L 11/18

(52) U.S. Cl. CPC H01M 2/046; H01M 2/26; H01M 2/0439; B60K 1/04; B60Y 2200/91; B60Y 2400/112; B60L 11/1879

(57) ABSTRACT

Provided herein is a battery cell of a battery pack to power an electric vehicle. The battery cell can include a housing having a body region and a head region. The housing can define an inner region. The head region can include an indentation. An electrolyte can be disposed within the inner region of the housing. A lid can include a positive lid portion, a negative lid portion, and a first isolation layer between the positive lid portion and the negative lid portion. The negative lid portion can include a crimped edge. The crimped edge can couple with the indentation of the head region of the housing.

### CROSS REFERENCE TO RELATED APPLICATION

The present application claims the benefit of priority under 35 U.S.C. § 119(e) to U.S. Provisional Application 62/646,981, filed on Mar. 23, 2018, titled “BATTERY CELL FOR ELECTRIC VEHICLE BATTERY PACK,” which is incorporated herein by reference in its entirety.

### BACKGROUND

Batteries can include electrochemical materials to supply electrical power to various electrical components connected thereto. Such batteries can provide electrical energy to various electrical systems.

### SUMMARY

At least one aspect is directed to a battery cell of a battery pack to power an electric vehicle. The battery cell can include a housing having a body region and a head region. The housing can define an inner region. The head region can include an indentation. An electrolyte can be disposed within the inner region of the housing. A lid can include a positive lid portion, a negative lid portion, and a first isolation layer between the positive lid portion and the negative lid portion. The negative lid portion can include a crimped edge. The crimped edge can couple with the indentation of the head region of the housing.

At least one aspect is directed to a method of providing electrical power via battery cells for battery packs to power an electric vehicle. The method can include providing a battery pack having a battery cell, the battery cell including a housing having a body region and a head region. The housing can define an inner region. The head region can include an indentation. The method can include disposing an electrolyte within the inner region of the housing and disposing a lid proximate to the head region of the housing. The lid can include a positive lid portion, a negative lid portion, and a first isolation layer between the positive lid portion and the negative lid portion. The method can include crimping the negative lid portion of the lid with the indentation of the head region of the housing to seal the battery cell.

At least one aspect is directed to a method of providing battery cells for battery packs to power an electric vehicle. The method can include providing a battery cell for a battery packs to power an electric vehicle. The battery cell can include a housing having a body region and a head region. The housing can define an inner region. The head region can include an indentation. An electrolyte can be disposed within the inner region of the housing. A lid can include a positive lid portion, a negative lid portion, and a first isolation layer between the positive lid portion and the negative lid portion. The negative lid portion can include a crimped edge. The crimped edge can couple with the indentation of the head region of the housing.

At least one aspect is directed to an electric vehicle. The electric vehicle can include a battery cell of a battery pack to power electric vehicles. The battery cell can include a housing having a body region and a head region. The housing can define an inner region. The head region can include an indentation. An electrolyte can be disposed within the inner region of the housing. A lid can include a positive lid portion, a negative lid portion, and a first isolation layer between the positive lid portion and the negative lid portion. The negative lid portion can include a crimped edge. The crimped edge can couple with the indentation of the head region of the housing.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1 is a block diagram depicting an example battery cell for a battery pack in an electric vehicle;

FIG. 2 is a block diagram depicting a cross-sectional view of an example battery cell for a battery pack in an electric vehicle;

FIG. 3 is a top view of a lid of a battery cell for a battery pack in an electric vehicle;

FIG. 4 is a block diagram depicting a cross-sectional view of an example battery pack for holding battery cells in an electric vehicle;

FIG. 5 is a block diagram depicting a cross-sectional view of an example electric vehicle installed with a battery pack; and

FIG. 6 is a flow diagram depicting an example method of providing battery cells for battery packs for electric vehicles; and

FIG. 7 is a flow diagram depicting an example method of providing battery cells for battery packs for electric vehicles.

### DETAILED DESCRIPTION

Following below are more detailed descriptions of various concepts related to, and implementations of battery cells for battery packs in electric vehicles. The various concepts introduced above and discussed in greater detail below can be implemented in any of numerous ways.

The architecture of the battery cells described here can simplify bonding of wires to a lid of the respective battery cells. For example, an outer edge of a negative lid portion of the lid can be crimped onto a first end of a housing of the battery cell to seal the battery cell and provide an increased surface area can be provided for bonding. A head region (e.g., top end) of the housing can be indented to form an indentation to receive the crimped edge of the negative lid portion of the lid. Thus, the lid can couple with the housing by forming the crimped edge around or into the indentation. By forming crimped edge on the outer edge of the negative lid portion, an increased bonding area or bonding surface can be provided on a surface of the negative lid portion. For example, instead of deforming the negative lid portion to couple the lid with the head region and leaving having only a small area (e.g., 1 mm to 2 mm in width) for wire bonding, the negative lid portions as described here can be formed, for example, having a ring shape with a width of 2 mm to 17 mm, resulting in an increased wire bonding area. This facilitates coupling of the battery cell with other battery cells of a battery pack or with a drive train of an electric vehicle. The crimping techniques as described herein provide an increased surface area on the negative lid portion, thus providing an increased area available for bonding, thereby improving the pack assembly process by making it easier to bond wires to each battery cell.

The increased wire bonding area of the battery cells described herein can improve the pack assembly process by making it easier to bond wires to each battery cell. In addition, having both tabs (e.g., positive lid portion, negative lid portion) for the positive and the negative terminals on one end of the battery cell can eliminate wire bonding to one side of the battery pack and welding of a tab to another side of the battery cell (e.g., the bottom end or the crimped region). For example, the battery cell can be attached to a negative busbar by bonding a wire between the negative lid portion and the negative busbar and to a positive busbar by bonding another wire between the positive lid portion and the positive busbar. In this manner, a terminal or an electrode tab along the bottom of the battery cell can be eliminated from the structure.

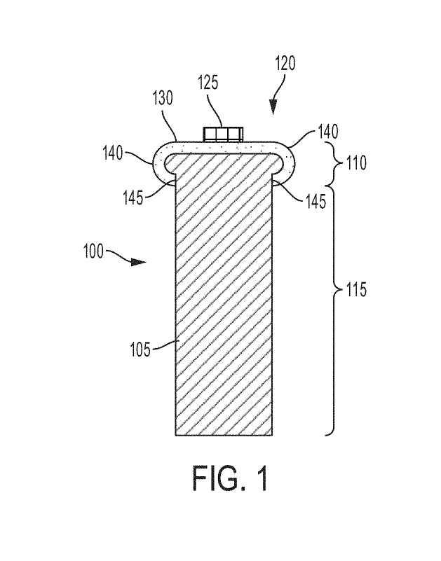

FIG. 1, among others, depicts a cross-sectional view of a battery cell 100 for a battery pack in an electric vehicle. The battery cell 100 can include a housing 105 having a head region 110 (e.g., first end, top end) and a body region 115 (e.g., second end, bottom end). The battery cell 100 can provide energy or store energy for an electric vehicle. For example, the battery cell 100 can be included in a battery pack used to power an electric vehicle. The battery cell 100 can be a lithium-air battery cell, a lithium ion battery cell, a nickel-zinc battery cell, a zinc-bromine battery cell, a zinc-cerium battery cell, a sodium-sulfur battery cell, a molten salt battery cell, a nickel-cadmium battery cell, or a nickel-metal hydride battery cell, among others. The housing 105 can be included or contained in a battery pack (e.g., a battery array or battery module) installed a chassis of an electric vehicle. The housing 105 can have the shape of a cylindrical casing or cylindrical cell with a circular, ovular, or elliptical base, as depicted in the example of the battery cell of FIG. 1. A height of the housing 105 can be greater than a width of the housing 105. For example, the housing 105 can have a length (or height) in a range from 65 mm to 75 mm and a width (or diameter for circular examples) in a range from 17 mm to 25 mm. In some examples the width or diameter of the housing 105 can be greater than the length (e.g., height) of the housing 105. The housing 105 can be formed from a prismatic casing with a polygonal base, such as a triangle, square, a rectangular, a pentagon, or a hexagon, for example. A height of such a prismatic cell housing 105 can be less than a length or a width of the base of the housing 105. The battery cell can be a cylindrical cell 21 mm in diameter and 70 mm in height. Other shapes and sizes are possible, such as a rectangular cells or rectangular cells with rounded edges, of cells between 17 mm to 25 mm in diameter or width, and 65 mm to 75 mm in length or height.

The battery cells 100 described herein can include both the positive terminal (e.g., positive lid portion 125) and the negative terminal (e.g., negative lid portion 130) disposed at a same lateral end (e.g., the top end) of the battery cell 100. The battery cells 100 can be coupled to positive and negative current collectors of the battery module through positive and negative portions of the respective battery cell. For example, the battery cell 100 can include at least one lid 120. The lid 120 can be coupled with or disposed onto the first lateral end (or head region 110) of the housing 105. The lid 120 can include a current interrupter device (e.g., CID), an electrical fuse, a thermal fuse, a rupture disk, or a printed circuit board (PCB) protection board, among others. For example, the CID, in response to an occurrence of a failure condition (e.g., excess voltage over 4.0 volts or pressure above 1,000 kPa), the CID of the lid 120 can initially electrically decouple the battery cell 100 from one or bus bars the respective battery cell 100 is coupled with. The lid 120 can include a positive portion 125 and a negative portion 130. For example, the positive lid portion 125 can operate as the positive terminal of the battery and the negative lid portion 130 can operate as the negative terminal of the battery cell 100. Via a module tab connection (or other technique such as wire bonding) the positive lid portion 125 and the negative lid portion 130 can couple the battery cells 100 with current collectors of the battery module from lateral ends (e.g., top or bottom) or from the longitudinal sides of the respective battery cells 100. For example, the battery cell 100 can couple with positive and negative current collectors of a battery module of an electric vehicle through the positive lid portion 125 and the negative lid portion 130 of the lid 120. One or more battery modules can form a battery pack disposed in an electric vehicle to power a drive train of the electric vehicle.

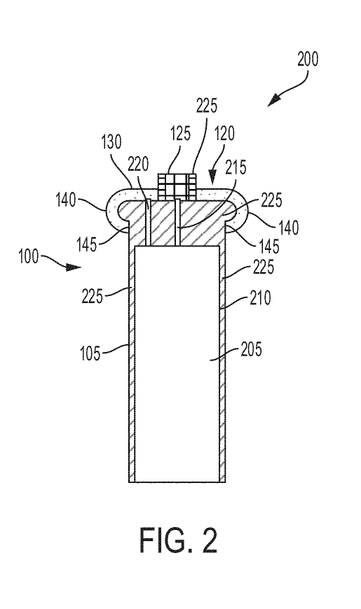

The battery cells 100 can be formed using a cap and case (or lid and can) design such that a larger area is provided to couple the electrical wires to the battery terminals (e.g., to the positive lid portion 125 or to the negative lid portion 130) and an increased interior area (or volume) within the housing or can 105 of the battery cells 100 is provided to support a larger electrolyte, (e.g., electrolyte 205 of FIG. 2). The larger electrolyte (e.g., greater than 65 mm in length) can result in a higher powered battery cell 100 relative to a battery cell having a crimped design with a gasket to hold at least one terminal in place at a lateral end of the battery cell.

The head region 110 can correspond to a part of the housing 105 for the battery cell 100 from the body region 115 to one end of the housing 105 (e.g., the top end as depicted in FIG. 1). The head region 110 can include any part of the housing 105 not including the body region 115. The head region 110 can include or be formed having an indentation or indentation shape. For example, the head region 110 can include or be defined by a bend or indentation 145 having a grooved such that it protrudes towards an inner region of the housing 105 with respect to a plane of an outer surface of the body region 115. The indentation 145 of the head region 110 can be formed by crimping, squeezing, or applying any pressure on an outer surface of the housing 105 along one axis. The indentation 145 of the head region 110 can have a width less than a width of the body region 115. For example, the width of the indentation 145 can be in a range from 15 mm to 20 mm. The width of the head region 110 (not including the indentation) can be in a range from 15 mm to 27 mm. The width can correspond to a shortest dimension along an inner surface of the housing 105 within the indentation 145, head region 110, or body region 115. The width can correspond to a width of a rectangular or polygonal lateral area of the indentation 145, head region 110, or body region 115. The width can correspond to a diameter of a circular or elliptical lateral area of the indentation 145, head region 110, or body region 115. The lateral area of the indentation 145 can also be less than a lateral area of the head region 110 (not including the indentation) and a lateral area of the body region 115. The width of the head region 110 (not including the indentation) can be less than the width of the body region 115 but greater than the width of the indentation 145. The lateral area of the head region 110 (not including the indentation) can be less than the lateral area of the body region 115 but greater than the lateral area of the indentation 145.

The body region 115 can correspond to a part of the housing 105 for the battery cell 100 from the head region 110 to one end of the housing 105 (e.g., the bottom end as depicted in FIG. 1). The body region 115 can include any part of the housing 105 not including the head region 110. The body region 115 can include an end of the housing 105 corresponding to a bottom surface of the battery cell 100. The width of the of the body region 115 can be in a range from 15 mm to 27 mm.

The negative lid portion 130 can include at least one crimped edge 140. For example, the crimped edge 140 can form a perimeter, an outer edge or an outer side surface for the negative lid portion 130. The crimped edge 140 can be formed such that the outer edge of negative lid portion 130 (i.e., the crimped edge 140) protrudes towards the indentation 145 of the head region 110 to couple with the indentation 145 of the head region 110. For example, the crimped edge 140 can be formed by crimping, compressing, bending, or applying any pressure on an outer edge area of the negative lid portion 130. The crimped edge 140 of the negative lid portion 130 can be positioned to apply a force at a predetermined level to an outer surface of the head region 110 and the indentation 145 to seal the battery cell 100. The crimped edge 140 can have a shape corresponding to the shape of the indentation 145 of the head region 110 to clip onto the head region 110 and seal the battery cell 100. The indentation 145 can have a shape to receive the crimped edge 140 of the negative lid portion 130. For example, the crimped edge 140 can be formed such that it forms a seal with the indentation 145 when coupled with the indentation 145. The crimped edge 140 can have dimensions corresponding to the dimensions of the indentation 145 of the head region 110. The crimped edge 140 can be formed having a length of 1 mm to 3 mm. For example, a length the crimped edge extends around and into the indentation 145 can be in a range from 1 mm to 3 mm. The distance the crimped edge 140 protrudes inward or bends inward towards the indentation 145 can be the same as a depth of the indentation 145.

The positive lid portion 125 can be formed having a greater height than the negative lid portion 130 with respect to a surface (e.g., top surface) of the head region 110. The positive lid portion 125 can be formed having a different height than the negative lid portion 130 to provide surfaces for bonding different polarities (e.g., positive terminal, negative terminal) at different heights within a battery module or battery pack. With respect to a surface (e.g., top surface) of the head region 110. For example, the positive lid portion 125 can be formed having a first height with respect to the head region 110 of the housing 105. The negative lid portion 130 can be formed having a second height with respect to the head region 110 of the housing 105. The first height of the positive lid portion 125 can be greater than the second height of the negative lid portion 130. The height difference (or lateral length) between the positive lid portion 125 and the negative lid portion 130 with respect to the head region 110 can range from 1 mm to 4 mm. For example, the height difference (or lateral length) between the positive lid portion 125 and the negative lid portion 130 with respect to the head region 110 can be 2 mm.

FIG. 2 depicts a cross-sectional view 200 of the battery cell 100 having an electrolyte 205 disposed within an inner region 210 of the housing 105. At least one isolation layer 225 can be disposed between the electrolyte 205 and the lid 120. At least one isolation layer 225 can be disposed between the positive lid portion 125 and the negative lid portion 130. At least one positive tab 215 can couple positive portions of the electrolyte 205 to the positive lid portion 125 of the lid 120. At least one negative tab 220 can couple negative portions of the electrolyte 205 to the negative lid portion 130 of the lid 120. The housing 105 of the battery cell 100 can include at least one electrically or thermally conductive material, or combinations thereof. The electrically conductive material can also be a thermally conductive material. The electrically conductive material for the housing 105 of the battery cell 100 can include a metallic material, such as aluminum, an aluminum alloy with copper, silicon, tin, magnesium, manganese or zinc (e.g., of the aluminum 4000 or 5000 series), iron, an iron-carbon alloy (e.g., steel), silver, nickel, copper, and a copper alloy, among others. The electrically conductive material and thermally conductive material for the housing 105 of the battery cell 100 can include a conductive polymer. To evacuate heat from inside the battery cell 100, the housing 105 can be thermally coupled to a thermoelectric heat pump (e.g., a cooling plate) via an electrically isolation layer.

The housing 105 can include an electrically insulating material. The electrically insulating material can be a thermally conductive material. The electrically insulating and thermally conductive material for the housing 105 of the battery cell 100 can include a ceramic material (e.g., silicon nitride, silicon carbide, titanium carbide, zirconium dioxide, beryllium oxide, and among others) and a thermoplastic material (e.g., polyethylene, polypropylene, polystyrene, or polyvinyl chloride), among others. To evacuate heat from inside the battery cell 100, the housing 105 can be thermally coupled to a thermoelectric heat pump (e.g., a cooling plate). The housing 105 can be directly thermally coupled to the thermoelectric heat pump without an addition of an intermediary electrically isolation layer.

The housing 105 of the battery cell 100 can include the head region 110 (e.g., top portion) and the body region 115 (e.g., bottom portion). The housing 105 can define an inner region 210 between the head region 110 and the body region 115. For example, the inner region 210 can include an interior of the housing 105. The head region 110, inner region 210, and the body region 115 can be defined along one axis of the housing 105. For example, the inner region 210 can have a width (or diameter for circular examples) of 2 mm to 6 mm and a length (or height) of 50 mm to 70 mm. The head region 110, inner region 210, and the body region 115 can be defined along a vertical (or longitudinal) axis of cylindrical casing forming the housing 105. The head region 110 can be at one end of the housing 105 (e.g., a top portion as depicted in FIG. 1). The body region 115 can be at an opposite end of the housing 105 (e.g., a bottom portion as depicted in FIG. 1). The end of the body region 115 can encapsulate or cover the corresponding end of the housing 105.

At least one electrolyte 205 can be disposed in the inner region 210 of the housing 105. The electrolytes 205 can include a negative electronic charge region or terminus and a positive electronic charge region or terminus. At least one negative tab 220 can couple the electrolytes 205 (e.g., negative region of electrolytes 205) with the surface of the housing 105 or the negative lid portion 130 of the lid 120. For example, a negative portion of the electrolytes 205 can be coupled with one or more surfaces of the housing 105 or the negative lid portion 130 of the lid 120, such as to form a negative surface area on the lid 120 for negative wire bonding. A positive portion of the electrolyte 205 can be coupled to the positive lid portion 125 of the lid 120 through a positive tab 215 to form a positive surface area on the lid 120 for positive wire bonding. Thus, the lid 120 can include a negative surface area and a positive surface area. The negative portion or the positive portion of the electrolyte 205 can be coupled with the housing 105 or the lid 120 through negative or positive tabs, respectively. An isolation layer 225 may be disposed between an inner surface of the housing 105 and the electrolytes 205 disposed within the inner region of the housing 105 to electrically insulate the housing 105 from the electrolytes 205.

The electrolyte 205 can include any electrically conductive solution, dissociating into ions (e.g., cations and anions). For a lithium-ion battery cell, for example, the electrolyte 205 can include a liquid electrolyte, such as lithium bisoxalatoborate (LiBC4O8 or LiBOB salt), lithium perchlorate (LiClO4), lithium hexaflourophosphate (LiPF6), and lithium trifluoromethanesulfonate (LiCF3SO3). The electrolyte 205 can include a polymer electrolyte, such as polyethylene oxide (PEO), polyacrylonitrile (PAN), poly(methyl methacrylate) (PMMA) (also referred to as acrylic glass), or polyvinylidene fluoride (PVdF). The electrolyte 205 can include a solid-state electrolyte, such as lithium sulfide (Li2S), magnesium, sodium, and ceramic materials (e.g., beta-alumna).

A single electrolyte 205 can be disposed within inner region 210 of the housing 105 or multiple electrolytes 205 (e.g., two electrolytes, more than two electrolytes) can be disposed within inner region 210 of the housing 105. For example, two electrolytes 205 can be disposed within inner region 210 of the housing 105. The number of electrolytes 205 can vary and can be selected based at least in part on a particular application of the battery cell 100.

At least one isolation layer 225 can electrically insulate portions of the lid 120 (e.g., positive lid portion 125, negative lid portion 130) from the electrolyte 205. The isolation layer 225 can be disposed between the lid 120 and the electrolyte 205. For example, an isolation layer 225 can be disposed between the negative lid portion 130 and a surface (e.g., top surface) of the electrolyte 205 or between the positive lid portion 125 and a surface (e.g., top surface) of the electrolyte 205. The isolation layer 225 can include one or more holes or apertures. For example, the isolation layer 225 can include one or more holes or apertures for a positive tab 215 and a negative tab 220 to be disposed to couple the electrolyte 205 with the lid 120. For example, the positive tab 215 can be disposed in a first hole or aperture of the isolation layer 225 and extend from a positive surface of the electrolyte 205 to a surface of the positive lid portion 125. The positive tab 215 can be disposed in a first hole or aperture of the isolation layer 225 and extend from a negative surface of the electrolyte 205 to a surface of the negative lid portion 130. Thus, the isolation layer 225 can electrically isolate the positive tab 215 from the negative tab 220.

The isolation layer 225 can include nonconductive layer or non-conductive material, and can electrically isolate the electrolyte 205 from the lid 120, the positive lid portion 125, or the negative lid portion 130. For example, the isolation layer 225 can include insulation material, plastic material, epoxy material, FR-4 material, polypropylene materials, or formex materials. The dimensions or geometry of the isolation layer 225 can be selected to provide a predetermined creepage clearance or spacing (sometimes referred to as creepage-clearance specification or requirement) between the electrolyte 205 and the lid 120 (e.g., positive lid portion 125, negative lid portion 130). For example, a thickness or width of the isolation layer 225 can be selected such that the electrolyte 205 is spaced at least in a range from 2 mm to 3 mm from the negative lid portion 130 and positive lid portion 125 when the isolation layer 225 is disposed between the jelly-roll of the electrolyte 205 and the negative lid portion 130 and the positive lid portion 125. The isolation layer 225 can be formed having a shape or geometry that provides the predetermined creepage, clearance or spacing.

The lid 120 can couple with the electrolyte 205 through at least one positive tab 215 or at least one negative tab 220. For example, a negative tab 220 can couple the electrolyte 205 with the negative lid portion 130 of the lid 120. When the negative lid portion 130 of the lid 120 is coupled with the electrolyte 205 through the negative tab 220, the housing 105 may include non-conductive material. A positive tab 215 can couple the electrolyte 205 (e.g., positive region of electrolyte 205) with the positive lid portion 125 of the lid 120. The negative tab 220 can be welded or otherwise coupled to the negative lid portion 130 of lid 120 and to the negative portion of the electrolyte 205. The positive tab 215 can be welded or otherwise coupled to the positive lid portion 125 of the lid 120 and to the positive portion of the electrolyte 205. In lieu of a negative tab 220, the housing 105 can electrically couple the electrolyte 205 with the negative lid portion 130 of the lid 120. The negative lid portion 130 may include one or more holes, openings, or apertures to allow a connection from the positive lid portion 125 to the electrolyte 205 through the positive tab 215. For example, the positive tab 215 can extend through the one or more holes, openings, or apertures of the negative lid portion 130 to couple the positive lid portion 125 with the electrolyte 205.

The positive tab 215 and the negative tab 220 can include aluminum, plastic materials or steel materials (e.g., alloy steel, carbon steel). For example, the positive tab 215 can include aluminum material and the negative tab 220 can include copper material. The positive tab 215 and the negative tab 220 can include any device or materials that can store energy or receive energy from one or more elements in contact with respective device or provide energy to one or more elements in contact with respective device. The dimensions of the positive tab 215 and the negative tab 220 can correspond to the dimensions (e.g., height) of the electrolyte 205 and the dimensions (e.g., height) of the housing 105. For example, the positive tab 215 and the negative tab 220 can be sized to accommodate the electrolyte 205 disposed within the housing 105 and under the lid 120. The positive tab 215 and the negative tab 220 can have a length or height in a range from 0.5 mm to 5 mm. For example, the positive tab 215 and the negative tab 220 can have dimensions, such as but not limited to, 0.5 mm in thickness×3 mm to 5 mm in width.

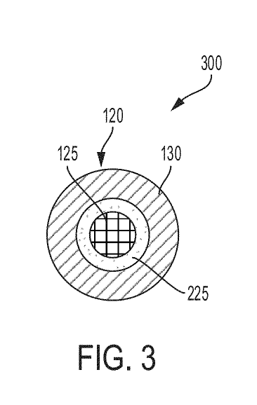

FIG. 3 depicts a top view 300 of the lid 120. The lid 120 can the positive lid portion 125, the negative lid portion 130 and an isolation layer 225 formed or disposed between the positive lid portion 125 and the negative lid portion 130. The isolation layer 225 can include a nonconductive layer or non-conductive material, and can electrically isolate the positive lid portion 125 from the negative lid portion 130. For example, the isolation layer 225 can be positioned to prevent or avoid a short circuit between the positive lid portion 125 and the negative lid portion 130.

The lid 120 can include at least one electrically or thermally conductive material, or combinations thereof. The electrically conductive material can also be a thermally conductive material. The electrically conductive material for the lid 120 (including the positive lid portion 125 and negative lid portion 130) can include a metallic material, such as aluminum, an aluminum alloy with copper, silicon, tin, magnesium, manganese or zinc (e.g., of the aluminum 5000 or 6000 series), iron, an iron-carbon alloy (e.g., steel), silver, nickel, copper, and a copper alloy, among others. The lid 120 can have a thickness in a range from 1 mm to 5 mm. For example, the lid 120 can have a thickness of 3 mm. The lid 120 can be formed having a diameter in a range from 17 mm to 30 mm. For example, the diameter of the lid 120 can be 21 mm.

The positive lid portion 125 can have a thickness or diameter in a range from 2 mm to 17 mm. For example, the positive lid portion 125 can have a thickness or diameter of 2 mm. The negative lid portion 130 can have a thickness in a range from 2 mm to 17 mm. For example, the negative lid portion 130 can have a thickness or diameter of 4 mm. For example, the distance from a border between the isolation layer 225 and the negative lid portion 130 to an outer edge (e.g., opposite edge from border between the isolation layer 225 and the negative lid portion 130) of the negative lid portion 130 can be in a range from 2 mm to 17 mm. A distance between or distance separating the positive lid portion 125 and the negative lid portion 130 can correspond to a thickness of the isolation layer 225. The isolation layer 225 can have a thickness in a range from 0.5 mm to 8 mm. For example, a distance from a first border between the isolation layer 225 and the positive lid portion 125 to a second border between the isolation layer 225 and the negative lid portion 130 can be in a range from 0.5 mm to 8 mm. The spatial separation between the positive lid portion 125 and the negative lid portion 130 can allow for suitable or sufficient bonding spacing and the avoidance of electrical arcing between positive wirebonds or connections to the positive lid portion 125 and negative wirebonds or connections to the negative lid portion 130.

The isolation layer 225 can include a ring insulator. For example, a ring isolation layer 225 can be disposed between the positive lid portion 125 and the negative lid portion 130 to electrically isolate the positive lid portion 125 and the negative lid portion 130. The isolation layer 225 can hold or bind the positive lid portion 125 and the negative lid portion 130 together. For example, the isolation layer 225 can include or use adhesive(s) or other binding material(s) or mechanism(s) to hold or bind the positive lid portion 125 and the negative lid portion 130 together.

The isolation layer 225 can include insulation material, plastic material, epoxy material, FR-4 material, polypropylene materials, or formex materials. The dimensions or geometry of the isolation layer 225 can be selected to provide a predetermined creepage clearance or spacing (sometimes referred to as creepage-clearance specification or requirement) between the positive lid portion 125 and the negative lid portion 130. For example, a thickness or width of the isolation layer 225 can be selected such that the positive lid portion 125 is spaced at least 3 mm from the negative lid portion 130 when the isolation layer 225 is disposed between the positive lid portion 125 and the negative lid portion 130. The isolation layer 225 can be formed having a shape or geometry that provides the predetermined creepage, clearance or spacing.

The thickness and insulating structure of the isolation layer 225, that separate the positive lid portion 125 and the negative lid portion 130, can provide the predetermined creepage, clearance or spacing. Thus, the dimensions of the isolation layer 225 can be selected, based in part, to meet creepage-clearance specifications or requirements. The dimensions of the isolation layer 225 can be configured to reduce or eliminate arcing between the positive lid portion 125 and the negative lid portion 130.

The isolation layer 225 can enable or support the lamination, and can include an isolation material or insulation material having high dielectric strength that can provide electrical isolation between the positive lid portion 125 and the negative lid portion 130. The lamination layer can provide a conformal coating that is disposed over one or more portions of the positive lid portion 125, the isolation layer 225, or the negative lid portion 130, and can protect against shorting from the positive lid portion 125 and the negative lid portion 130.

The lid 120 can be formed having a variety of different shapes. The shape of the lid 120 can correspond to or be the same as the shape of the housing 105 of the battery cell 100. For example, the lid 120 can be formed having a circular shape (as shown in FIG. 3). The lid 120 can be formed having, but not limited to, a square shape, rectangular shape, or octagonal shape.

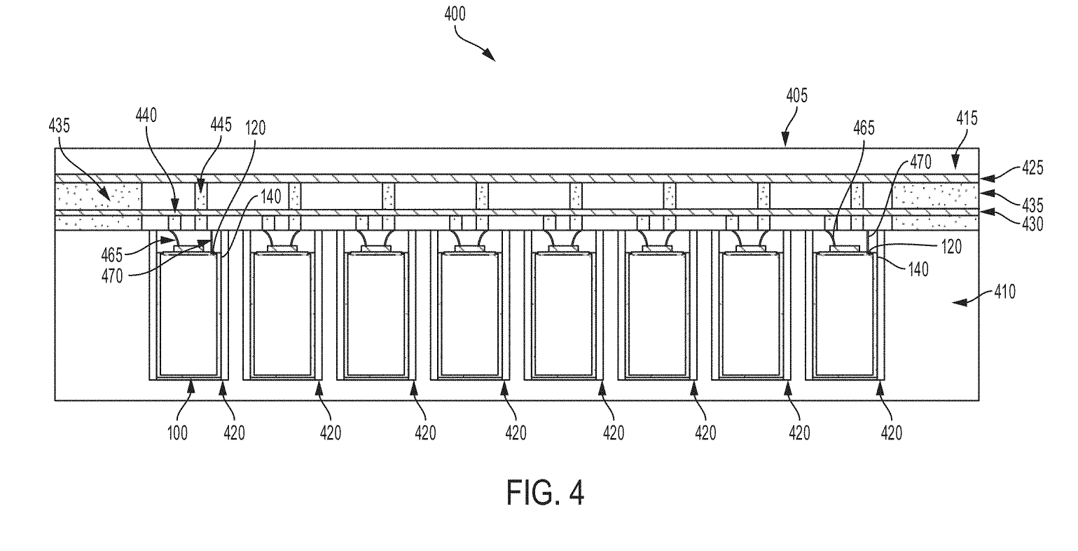

FIG. 4 depicts a cross-section view 400 of a battery pack 405 to hold a plurality of battery cells 100 in an electric vehicle. The battery pack 405 can include at least one battery cell 100 having a lid 120. The lid 120 can include at least one crimped edge 140 to couple the lid 120 with the battery cell 100. For example, the crimped edge 140 can have a shape corresponding to a shape of an indentation 145 of a head region 110 of the respective battery cell 100 to clip onto the head region 110 and seal the battery cell 100. The battery pack 405 can include a battery case 410 and a capping element 415. The battery case 410 can be separated from the capping element 415. The battery case 410 can include or define a plurality of holders 420. Each holder 420 can include a hollowing or a hollow portion defined by the battery case 410. Each holder 420 can house, contain, store, or hold a battery cell 100. The battery case 410 can include at least one electrically or thermally conductive material, or combinations thereof. The battery case 410 can include one or more thermoelectric heat pumps. Each thermoelectric heat pump can be thermally coupled directly or indirectly to a battery cell 100 housed in the holder 420. Each thermoelectric heat pump can regulate temperature or heat radiating from the battery cell 100 housed in the holder 420. The first bonding element 465 and the second bonding element 470 can extend from the battery cell 100 through the respective holder 420 of the battery case 410.

Between the battery case 410 and the capping element 415, the battery pack 405 can include a first busbar 425, a second busbar 430, and an electrically isolation layer 435. The first busbar 425 and the second busbar 430 can each include an electrically conductive material to provide electrical power to other electrical components in the electric vehicle. The first busbar 425 (sometimes referred to herein as a first current collector) can be connected or otherwise electrically coupled to the first bonding element 465 extending from each battery cell 100 housed in the plurality of holders 420 via a bonding element 445. The bonding element 445 can include electrically conductive material, such as but not limited to, a metallic material, aluminum, or an aluminum alloy with copper. The bonding element 445 can extend from a positive lid portion 125 of a lid 120 of at least one battery cell 100 to the first busbar 425. The bonding element 445 can be bonded, welded, connected, attached, or otherwise electrically coupled to the second bonding element 470 extending from the battery cell 100. The first bonding element 465 can define the first polarity terminal for the battery cell 100. The first busbar 425 can define the first polarity terminal for the battery pack 405. The second busbar 430 (sometimes referred to as a second current collector) can be connected or otherwise electrically coupled to the second bonding element 470 extending from each battery cell 100 housed in the plurality of holders 420 via a bonding element 440. The bonding element 440 can include electrically conductive material, such as but not limited to, a metallic material, aluminum, or an aluminum alloy with copper. The bonding element 440 can extend from a negative lid portion 130 of a lid 120 of at least one battery cell 100 to the second busbar 430. The bonding element 440 can be bonded, welded, connected, attached, or otherwise electrically coupled to the second bonding element 470 extending from the battery cell 100. The second bonding element 470 can define the second polarity terminal for the battery cell 100. The second busbar 430 can define the second polarity terminal for the battery pack 405.

The first busbar 425 and the second busbar 430 can be separated from each other by the electrically isolation layer 435. The electrically isolation layer 435 can include any electrically insulating material or dielectric material, such as air, nitrogen, sulfur hexafluoride (SF₆), porcelain, glass, and plastic (e.g., polysiloxane), among others to separate the first busbar 425 from the second busbar 430. The electrically isolation layer 435 can include spacing to pass or fit the first bonding element 465 connected to the first busbar 425 and the second bonding element 470 connected to the second busbar 430. The electrically isolation layer 435 can partially or fully span the volume defined by the battery case 410 and the capping element 415. A top plane of the electrically isolation layer 435 can be in contact or be flush with a bottom plane of the capping element 415. A bottom plane of the electrically isolation layer 435 can be in contact or be flush with a top plane of the battery case 410.

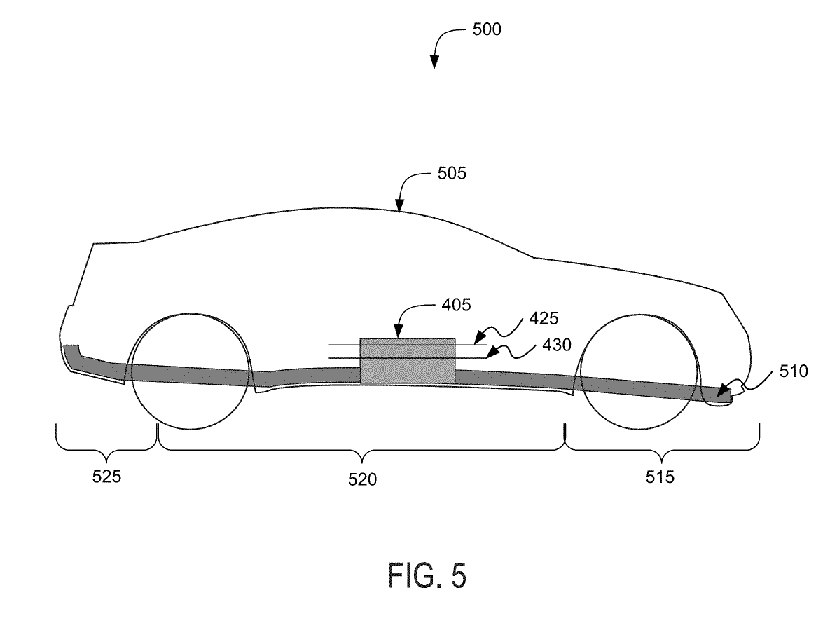

FIG. 5 depicts a cross-section view 500 of an electric vehicle 505 installed with a battery pack 405. The battery pack 405 can include at least one battery cell 100 having at least one crimped edge 140 coupled with an indentation 145 of a head region 110 of a housing 105 of the respective battery cell 100. For example, the battery cells 100 described herein can be used to form battery packs 405 residing in electric vehicles 505 for an automotive configuration to power drivetrains or other components of the electric vehicles 505. An automotive configuration includes a configuration, arrangement or network of electrical, electronic, mechanical or electromechanical devices within a vehicle of any type. An automotive configuration can include battery cells for battery packs in vehicles such as electric vehicles (EVs). EVs can include electric automobiles, cars, motorcycles, scooters, passenger vehicles, passenger or commercial trucks, and other vehicles such as sea or air transport vehicles, planes, helicopters, submarines, boats, or drones. EVs can be fully autonomous, partially autonomous, or unmanned. Thus, the electric vehicle 505 can include an autonomous, semi-autonomous, or non-autonomous human operated vehicle. The electric vehicle 505 can include a hybrid vehicle that operates from on-board electric sources and from gasoline or other power sources.

The electric vehicle 505 can include automobiles, cars, trucks, passenger vehicles, industrial vehicles, motorcycles, and other transport vehicles. The electric vehicle 505 can include a chassis 510 (sometimes referred to herein as a frame, internal frame, or support structure). The chassis 510 can support various components of the electric vehicle 505. The chassis 510 can span a front portion 515 (sometimes referred to herein a hood or bonnet portion), a body portion 520, and a rear portion 525 (sometimes referred to herein as a trunk portion) of the electric vehicle 505. The front portion 515 can include the portion of the electric vehicle 505 from the front bumper to the front wheel well of the electric vehicle 505. The body portion 520 can include the portion of the electric vehicle 505 from the front wheel well to the back wheel well of the electric vehicle 505. The rear portion 525 can include the portion of the electric vehicle 505 from the back wheel well to the back bumper of the electric vehicle 505.

The battery pack 405 that includes at least one battery cell 100 having at least one crimped edge 140 coupled with an indentation 145 of a head region 110 of a housing 105 of the respective battery cell 100 can be installed or placed within the electric vehicle 505. For example, the battery pack 405 can couple with a drive train unit of the electric vehicle 505. The drive train unit may include components of the electric vehicle 505 that generate or provide power to drive the wheels or move the electric vehicle 505. The drive train unit can be a component of an electric vehicle drive system. The electric vehicle drive system can transmit or provide power to different components of the electric vehicle 505. For example, the electric vehicle drive train system can transmit power from the battery pack 405 to an axle or wheels of the electric vehicle 705. The battery pack 405 can be installed on the chassis 510 of the electric vehicle 505 within the front portion 515, the body portion 520 (as depicted in FIG. 5), or the rear portion 525. A first bus-bar 425 and a second bus-bar 430 can be connected or otherwise be electrically coupled with other electrical components of the electric vehicle 505 to provide electrical power from the battery pack 405 to the other electrical components of the electric vehicle 505. For example, the first busbar 425 can couple with a positive lid portion 125 of the lid 120 of at least one battery cell 100 of the battery pack 405 through a wirebond or bonding element (e.g., bonding element 445 of FIG. 4). The second busbar 430 can couple with a negative lid portion 130 of the lid 120 of at least one battery cell 100 of the battery pack 405 through a wirebond or bonding element (e.g., bonding element 440 of FIG. 4).

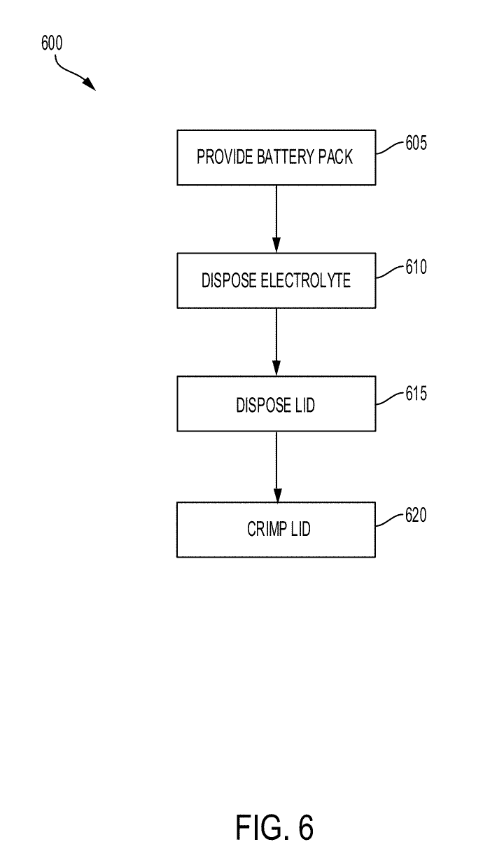

FIG. 6 depicts a method 600 of providing electrical power via the battery cell 100 of the battery pack 405 to provide electrical power to the electric vehicle 505. The method 600 can include providing a battery pack (ACT 605) that for example can include battery cell 100 with a housing 105 having a head region 110 and a body region 115 and defining an inner region 210. Providing the battery pack (ACT 605) can include providing at least one battery pack 405 that includes at least one battery cell 100 that has the housing 105. The housing 105 of a battery cell 100 can be provided. The housing can include a head region 110 (e.g., first end, top end) and a body region 115 (e.g., second end, bottom end). The housing 105 can be formed having or defining an inner region 210. The battery cell 100 can be a lithium ion battery cell, a nickel-cadmium battery cell, or a nickel-metal hydride battery cell. The battery cell 100 can be part of a battery pack 405 installed within a chassis 510 of an electric vehicle 505. The housing 105 can be formed from a cylindrical casing with a circular, ovular, elliptical, rectangular, or square base or from a prismatic casing with a polygonal base.

An indentation 145 can be formed on the head region 110. The indentation 145 of the head region 110 can be formed by crimping, squeezing, or applying any pressure on an outer surface of the housing 105 along one axis. The indentation 145 of the head region 110 can have a width less than a width of the body region 115. The indentation 145 can be formed having a shape and dimensions to receive a crimped edge 140 of a negative lid portion 130 of a lid 120. For example, the head region 110 can include or be defined by a bend or indentation 145 having a grooved such that it protrudes towards an inner region of the housing 105 with respect to a plane of an outer surface of the body region 115. The indentation 145 can couple with a crimped edge 140 to seal the battery cell 100.

The method 600 can include disposing an electrolyte 205 in the inner region 210 defined by the housing 105 (ACT 610). The electrolyte 205 can be disposed in the inner region 210 defined by the housing 105 of the battery cell 100. A single electrolyte 205 can be disposed within the inner region 210 or multiple electrolytes 205 (e.g., two or more) can be disposed within the inner region 210. The electrolytes 205 can be positioned within the inner region 210 such that they are spaced evenly from each other. For example, the electrolytes 205 can be positioned within the inner region 210 such that they are not in contact with each other. One or more isolation layers 225 may be disposed between different electrolytes 205 within the same or common inner region 210. The electrolytes 205 can be positioned within the inner region 210 such that they are spaced a predetermined distance from an inner surface of the housing 105. For example, one or more isolation layers 225 may be disposed between different inner surfaces of the housing 105 and the electrolytes 205 within the inner region 210 to insulate the housing 105 from the electrolytes 205. Thus, a distance the electrolytes 205 are spaced from the inner surface of the housing 105 can correspond to a thickness of the isolation layers 225.

One or more isolation layers 225 can be disposed between the electrolyte 205 and inner surfaces of the housing 105. For example, the isolation layers 225 can electrically insulate portions or surfaces of the housing 105 from the electrolyte 205. The isolation layers 225 can electrically insulate portions or surfaces of a lid 120 from the electrolyte 205. For example, one or more isolation layers 225 can be disposed over a top surface of the electrolyte 205. The isolation layers 225 can be disposed between the electrolytes 205 and portions of a lid 120. The isolation layer 225 can be formed having a ring shape. One or more holes or apertures can be formed in the isolation layers 225. For example, a positive tab 215 can be disposed within a first hole or aperture of the isolation layer 225 to couple positive portions of the electrolyte 205 with a positive lid portion 125 of a lid 120. A negative tab 220 can be disposed within a second hole or aperture of the isolation layer 225 to couple negative portions of the electrolyte 205 with a negative lid portion 130 of a lid 120. A positive tab 215 can be embedded within the isolation layer 225 to couple positive portions of the electrolyte 205 with a positive lid portion 125 of a lid 120. A negative tab 220 can be embedded within the isolation layer 225 to couple negative portions of the electrolyte 205 with a negative lid portion 130 of a lid 120.

The method 600 can include disposing a lid 120 proximate to the head region 110 of the housing 105 (ACT 615). The lid 120 can be formed having a positive lid portion 125, a negative lid portion 130, and a first isolation layer 225 between the positive lid portion 125 and the negative lid portion 130. For example, the method 600 can include forming a positive lid portion 125 of the lid 120. The positive lid portion 125 can be formed having a shape corresponding to the shape of the housing 105. For example, the positive lid portion 125 can be formed having a circular, ovular, elliptical, rectangular, or square shape.

The positive lid portion 125 can be formed having a diameter in a range from 2 mm to 17 mm. The first isolation layer 225 can be formed such that it is disposed between the positive lid portion 125 and the negative lid portion 130. For example, first isolation layer 225 can be formed or disposed such that it is in contact with at least one surface of the positive lid portion 125. The first isolation layer 225 can be formed or disposed around an outer perimeter or edge surface of the positive lid portion 125. The first isolation layer 225 can be formed or disposed under a bottom surface of the positive lid portion 125. The first isolation layer 225 can have a thickness in a range from 0.5 mm to 8 mm. The first isolation layer 225 may be filled with electrolyte. The negative lid portion 130 can be formed or disposed such that it is in contact with at least one surface of the first isolation layer 225. The negative lid portion 130 can be formed or disposed around an outer perimeter or edge surface of the first isolation layer 225. The negative lid portion 130 formed or disposed under a bottom surface of the first isolation layer 225. The negative lid portion 130 can have a thickness in a range from 2 mm to 17 mm (e.g., 4 mm). The method 600 can include electrically isolating the positive lid portion 125 from the negative lid portion 130 using the first isolation layer 225. For example, the first isolation layer 225 can be disposed or coupled between the positive lid portion 125 and the negative lid portion 130 to electrically insulate the positive lid portion 125 from the negative lid portion 130.

The method 600 can include crimped crimping the negative lid portion 130 of the lid 120 with the indentation 145 of the head region 110 of the housing 105 to seal the battery cell 100 (ACT 620). The negative lid portion 130 can include a crimped edge 140 disposed about the indentation 145 to couple the lid 120 with the head region 110 of the housing 105. For example, a perimeter, an outer edge or an outer side surface of the negative lid portion 130 can be crimped, compressed, or bended to form a crimped edge 140 that protrudes towards the indentation 145 of the head region 110. The crimped edge 140 can be bended such that it wraps around a grooved shape formed by the indentation 145 to seal the battery cell 100. The crimped edge 140 can be formed having a shape and dimensions to corresponding to the indentation 145. The crimped edge 140 can be formed having a length of 1 mm to 3 mm. For example, a length the crimped edge extends around and into the indentation 145 can be in a range from 1 mm to 3 mm. For example, the crimped edge 140 can be formed as a “male end” and the indentation 145 can be formed as a “female end” and the crimped edge 140 can protrude towards the indentation 145 and the indentation 145 can be sized to receive the crimped edge 140. To crimp the outer edge of the negative lid portion 130, one or more crimper dies can be applied to a surface of the negative lid portion 130 and crimp, compress or bend the outer edge until the crimped edge 140 are formed. The crimped edge 140 can be bended towards the indentation 145 such that the crimped edge 140 applies a predetermined amount of force on the outer surface of the head region 110 to seal the battery cell 100. The negative lid portion 130 can be formed such that an entire outer edge or perimeter is crimped, thus having a single crimped edge 140 formed around the perimeter of the negative lid portion 130. The negative lid portion 130 can be formed having multiple portions of the outer edge or perimeter crimped, thus having multiple crimped edges 140 formed around the perimeter of the negative lid portion 130.

By forming crimped edge 140 on the outer edge of the negative lid portion 130, an increased bonding area or bonding surface can be provided on a surface of the negative lid portion 130. For example, instead of deforming the negative lid portion 130 to couple the lid 120 to the head region 110 and leaving having only a small area (e.g., 1 mm to 2 mm in width) for wire bonding, the negative lid portions 130 as described here can be formed, for example, having a ring shape with a width of 2 mm to 17 mm, resulting in an increased wire bonding area. This facilitates coupling of the battery cell 100 with other battery cells of a battery pack 405 or with a drive train of an electric vehicle 505. The crimping techniques as described herein provide an increased surface area on the negative lid portion 130, thus providing an increased area available for bonding, thereby improving the pack assembly process by making it easier to bond wires to each battery cell 100.

The lid 120 can be disposed over a surface of the electrolyte 205 disposed within the inner region 210 such that isolation layers 225, positive tab 215, and negative tab 220 are disposed between the lid 120 and the surface of the electrolyte 205. For example, the lid 120 can be disposed over a top surface of the electrolyte 205 with isolation layers 225, positive tab 215, and negative tab 220 disposed between the lid 120 and the surface of the electrolyte 205. Thus, the lid 120 can be positioned such that it is not in contact with the electrolyte 205. The lid 120 can be spaced a predetermined distance from the top surface of the electrolyte 205. For example, the lid 120 can be spaced a distance from the electrolyte 205 corresponding to the dimensions of the isolation layers 225, positive tab 215, or negative tab 220.

The electrolyte 205 can electrically couple, through a positive tab 215, with the positive lid portion 125. The battery cell 100 can include positive tab 215, a negative tab 220 or both a positive tab 215 and a negative tab 220. The positive tab 215 can be disposed between a top surface of the electrolyte 205 and the lid 120. For example, the positive tab 215 can include a first end that is soldered or welded to a positive lid portion 125 and a second end that couples with a top surface of the electrolyte 205. Thus, the positive tab 215 can couple the electrolyte 205 with the positive lid portion 125 so that the lid 120 functions as a positive terminal. The positive tab 215 can be disposed within or embedded within an isolation layer 225 spacing the electrolyte 205 from the lid 120. For example, the positive tab 215 can be disposed such that it extends through the isolation layer 225 can couples the electrolyte 205 with the positive lid portion 125. The negative lid portion 130 may include a hole or aperture having an isolation layer 225 formed through the respective hole or aperture. The positive tab 215 can be disposed such that it extends through the insulated hole or insulated aperture in the negative lid portion 130 to couple the electrolyte 205 with the positive lid portion 125.

The electrolyte 205 can electrically couple, through a negative tab 220, with the negative lid portion 130. For example, a negative tab 220 can include a first end coupled with at least one surface of a negative region or negative portion of the electrolyte 205 and a second end coupled with at least one surface of the negative lid portion 130. The negative tab 220 can be soldered or welded to at least one surface (e.g., bottom surface, side surface) of the negative lid portion 130. Thus, the negative tab 220 can extend from the negative portion of the electrolyte 205 to the surface of the negative lid portion 130. The negative tab 220 can be disposed through (e.g., through an aperture or hole) or embedded within an isolation layer 225 disposed between the electrolyte 205 and the negative lid portion 130 to couple the electrolyte 205 with the negative lid portion 130.

The negative region or negative portion of the electrolyte 205 can electrically couple, through a negative tab 220, with the housing 105. For example, a negative tab 220 can include a first end coupled with at least one surface of a negative portion of the electrolyte 205 and a second end coupled with at least one surface of the housing 105. The negative tab 220 can be soldered or welded to an inner surface of the housing 105, such as but not limited to, an inner side surface of the housing 105 or an inner bottom surface of the housing 105. Thus, the negative tab 220 can extend from the negative portion of the electrolyte 205 to an inner surface of the housing 105. For example, the negative tab 220 can extend from the negative portion of the electrolyte 205 to a side inner surface of the housing 105 or a bottom inner surface of the housing 105.

The housing 105 can electrically couple with the negative lid portion 130 of the lid 120. For example, the negative lid portion 130 of the lid 120 can be crimped onto the head region 110 of the housing through the crimped edge 140 and indentation 145, thus electrically coupling the housing 105 with the negative lid portion 130. The housing 105 can (in addition to the negative lid portion 130) can function as a negative terminal. The method 600 can include electrically coupling, through a negative tab 220, the negative lid portion 130 with the housing 105. The housing 105 can electrically couple with the negative lid portion 130 through the negative tab 220. For example, via the negative tab 220, the negative lid portion 130 can electrically couple with the housing 105, which can be electrically coupled with the electrolyte 205 so that the negative lid portion 130 can function as the negative terminal for the battery cell 100.

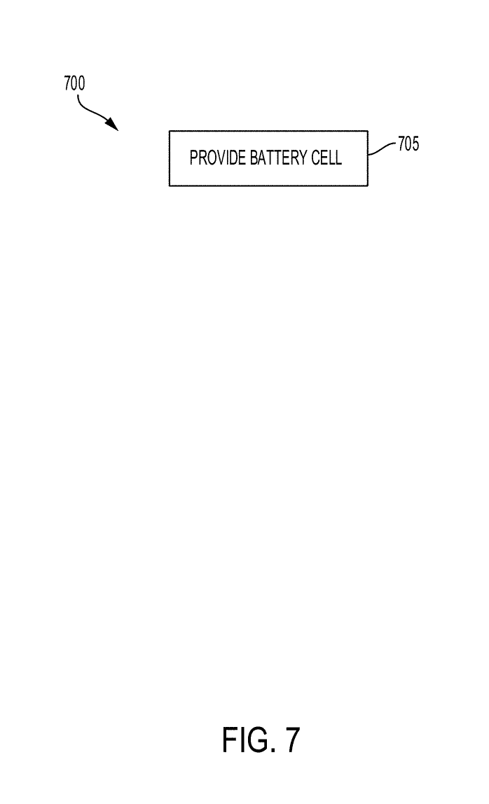

FIG. 7 depicts a method 700 of providing a battery cell 100 of a battery pack 405 for electric vehicles 505. The method 700 can include providing a battery cell 100 (ACT 705). The battery cell can include a housing 105. The housing 105 can include a body region 115 and a head region 110. The housing can define can an inner region 210. The head region 110 can include an indentation 145. An electrolyte 205 can be disposed within the inner region 210 of the housing 105. A lid 120 can include a positive lid portion 125, a negative lid portion 130, and a first isolation layer 225 between the positive lid portion 125 and the negative lid portion 130. The negative lid portion 130 can include a crimped edge 140. The crimped edge 140 can couple with the indentation 145 of the head region 110 of the housing 105.

While acts or operations may be depicted in the drawings or described in a particular order, such operations are not required to be performed in the particular order shown or described, or in sequential order, and all depicted or described operations are not required to be performed. Actions described herein can be performed in different orders.

Having now described some illustrative implementations, it is apparent that the foregoing is illustrative and not limiting, having been presented by way of example. Features that are described herein in the context of separate implementations can also be implemented in combination in a single embodiment or implementation. Features that are described in the context of a single implementation can also be implemented in multiple implementations separately or in various sub-combinations. References to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any act or element may include implementations where the act or element is based at least in part on any act or element.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can include implementations including a plurality of these elements, and any references in plural to any implementation or element or act herein can include implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

The systems and methods described herein may be embodied in other specific forms without departing from the characteristics thereof. For example the voltage across terminals of battery cells can be greater than 5V. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

Systems and methods described herein may be embodied in other specific forms without departing from the characteristics thereof. For example, descriptions of positive and negative electrical characteristics may be reversed. For example, elements described as negative elements can instead be configured as positive elements and elements described as positive elements can instead by configured as negative elements. Further relative parallel, perpendicular, vertical or other positioning or orientation descriptions include variations within +/−10% or +/−10 degrees of pure vertical, parallel or perpendicular positioning. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A battery cell of a battery pack to power an electric vehicle, the battery cell comprising:
a housing having a body region and a head region, the housing defining an inner region;
the head region having an indentation;
an electrolyte disposed within the inner region of the housing;
a lid that includes a positive lid portion, a negative lid portion, and a first isolation layer between the positive lid portion and the negative lid portion; and
the negative lid portion includes a crimped edge, and the crimped edge coupled with the indentation of the head region of the housing.

2. The battery cell of clam 1, comprising:
a positive tab that electrically couples the positive lid portion of the lid with a positive region of the electrolyte.

3. The battery cell of clam 1, comprising:
a negative tab that electrically couples the negative lid portion of the lid with a negative region of the electrolyte.

4. The battery cell of claim 1, comprising:
a second isolation layer disposed between the electrolyte and the lid;
a positive tab extending through the second isolation layer to couple the positive portion of the lid with a positive region of the electrolyte; and
a negative tab extending through the second isolation layer to couple the negative portion of the lid with a negative region of the electrolyte.

5. The battery cell of claim 1, comprising:
the crimped edge of the negative lid portion having a shape corresponding to the indentation of the head region to clip onto the head region and seal the battery cell; and
the indentation of the head region configured to receive the crimped edge of the negative lid portion.

6. The battery cell of claim 1, comprising:
the crimped edge of the negative lid portion positioned to apply a force at a predetermined level to an outer surface of the head region to seal the battery cell.

7. The battery cell of claim 1, comprising:
the positive lid portion having a first height with respect to the head region of the housing; and
the negative lid portion having a second height with respect to the head region of the housing, the first height is greater than the second height.

8. The battery cell of claim 1, comprising:
the positive lid portion electrically isolated from the negative lid portion by the first isolation layer.

9. The battery cell of claim 1, comprising:
the positive lid portion having a thickness in the range from 5 mm to 15 mm.

10. The battery cell of claim 1, comprising:
the negative lid portion having a thickness in the range from 5 mm to 15 mm.

11. The battery cell of claim 1, comprising:
the battery cell disposed in a battery module having multiple battery cells, the positive lid portion forming a positive terminal for the battery cell to couple with the battery module and the negative lid portion forming a negative terminal for the battery cell to couple with the battery module.

12. The battery cell of claim 1, comprising:
the battery cell disposed in a battery pack and the battery pack disposed in an electric vehicle.

13. A method of providing electrical power via a battery cell of a battery pack to power an electric vehicle, the method comprising:
providing a battery pack having a battery cell, the battery cell including a housing having a body region and a head region, the housing defining an inner region, the head region having an indentation;
disposing an electrolyte within the inner region of the housing;
disposing a lid proximate to the head region of the housing, the lid having a positive lid portion, a negative lid portion, and a first isolation layer between the positive lid portion and the negative lid portion; and
crimping the negative lid portion of the lid with the indentation of the head region of the housing to seal the battery cell.

14. The method of claim 13, comprising:
electrically coupling, through a positive tab, the positive lid portion of the lid with a positive region of the electrolyte.

15. The method of claim 13, comprising:
electrically coupling, through a negative tab, the negative lid portion of the lid with a negative region of the electrolyte.

16. The method of claim 13, comprising:
disposing a second isolation layer between the electrolyte and the lid;
extending a positive tab through the second isolation layer to couple the positive portion of the lid with a positive region of the electrolyte; and
extending a negative tab through the second isolation layer to couple the negative portion of the lid with a negative region of the electrolyte.

17. The method of claim 13, comprising:
forming the crimped edge of the negative lid portion having a shape corresponding to the indentation of the head region to clip onto the head region and seal the battery cell; and
forming the indentation of the head region to receive the crimped edge of the negative lid portion.

18. The method of claim 13, comprising:
coupling the crimped edge of the negative lid portion with an outer surface of the head region to seal the battery cell such that the crimped edge applies a force at a predetermined level to an outer surface of the head region to seal the battery cell.

19. The method of claim 13, comprising:
forming the positive lid portion having a first height with respect to the head region of the housing; and
forming the negative lid portion having a second height with respect to the head region of the housing, the first height is greater than the second height.

20. An electric vehicle, comprising:
a battery cell of a battery pack to power an electric vehicle comprising, the battery cell comprising:
a housing having a body region and a head region, the housing defining an inner region;
the head region having an indentation;
an electrolyte disposed within the inner region of the housing;
a lid that includes a positive lid portion, a negative lid portion, and a first isolation layer between the positive lid portion and the negative lid portion; and
the negative lid portion includes a crimped edge, and the crimped edge coupled with the indentation of the head region of the housing.
